(19) United States
(12) Patent Application Publication
(10) Pub. No.: US 2010/0194278 A1
(43) Pub. Date: Aug. 5, 2010

(54) Flow manipulation with micro plasma

(76) Inventor: Chien Ouyang, Sunnyvale, CA (US)

Correspondence Address: Chien Ouyang, 6335 Paseo Santa Cruz, Pleasanton, CA, 94566, US

(21) Appl. No.: 12/322,314

(22) Filed: Feb. 2, 2009

(51) Int. Cl. H05H 1/24

(52) U.S. Cl. 315/111.21

(57) ABSTRACT

The embodiments of the present invention apply the RF or microwave energy on electrically conductive traces and waveguide structures to excite micro plasma, and the micro plasma is manipulated to drive the micro fluid flow. The micro fluid flow is used to cool down electronic device, or used for the applications of gas fluid transportation, gas fluid mixture, and gas fluid reaction.

### BACKGROUND OF THE INVENTION

1. Field of the Invention

The present invention relates generally to a process and apparatus for manipulating the micro fluid flow using micro plasma. The micro plasma may be excited using microwave or RF electromagnetic waves on electrically conductive traces or waveguides structures. The manipulated micro fluid flow may be used for cooling and heating of electronic devices, for the delivery of fluid materials in the medical devices, for the fluid diagnostics in testing and measurement equipments, and for the gas mixing in the devices of micro reactors.

2. Description of the Related Art

Plasma technology is important in the growth areas of electronics, the car-, machine- and tool-making industries, energy technology, the optics industry, and the textile, the environmental, and the medical technology. This patent is focused on the manipulation of the micro fluid flow with micro plasma. The invention basically utilizes electrically conductive traces to generate micro plasma. By applying the RF or microwave energy to the electrically conductive traces or waveguides structures, the micro plasma may be strongly excited or weakly excited. With the manipulation of the parameters, such as, phases, amplitudes, waveforms, and time delays of the signals, and by imposing a magnetic field and electrical potentials to the nearby components, the micro flow field may be manipulated.

First of all, what is plasma? Plasma is the fourth state of matter. As we know, there are three states of matter; solid, liquid and gas, but there are actually four. The fourth one is plasma and it is the most common state of matter in the universe. Simply speaking, plasma is an ionized gas, a gas into which sufficient energy is provided to free electrons from atoms or molecules and to allow both ions and electrons to coexist. Plasma is common here on earth. Gases can become plasmas in several ways, but all include pumping the gas with energy. A spark in a gas will create the plasma. A hot gas passing through a big spark will turn the gas stream into the plasma that can be useful. Plasma torches like that are used in industry to cut metals. The biggest chunk of plasma we will see is that dear friend to all of us, the sun. The sun's enormous heat rips electrons off the hydrogen and helium molecules that make up the sun. Essentially, the sun, like most stars, is a great big ball of plasma.

Different from the big-scale plasma in the universe is the small scale of plasma, which is named micro plasma here. The micro plasma is getting more and more interest because of their potential applications in many technology fields. For example, in the field of semiconductor processing, such as U.S. Pat. No. 7,022,615, a micro plasma processing method is proposed to process a metal or a semiconductor surface. By applying activated particles, which are generated by a micro plasma, to the metal or semiconductor surfaces, the oxide film of the surfaces can be removed or etched away. The claimed operating pressure may be not lower than 10,000 Pa and not higher than three atmospheric pressures.

In U.S. Pat. No. 7,056,416, the atmospheric pressure plasma processing method and apparatus is proposed. The patent provided is a plasma processing method for generating micro plasma in a space of a micro plasma source arranged in the vicinity of an object to be processed by supplying gas to the space and supplying electric power to a member located in the vicinity of the space, making activated particles emitted from an opening of the micro plasma source joined to the space act on the object, and forming a fine linear portion on the object. The fine linear portion is formed on the object while flowing the gas to the neighborhood of the opening along the lengthwise direction of the fine linear portion parallel to the object.

In U.S. Pat. No. 6,917,165, a low power plasma generator is provided which can be fabricated in micro-miniature size and which is capable of efficient portable operation. Their plasma generator comprises a microwave stripline high Q resonant ring. The generator is well suited for low power portable and other applications and can be readily fabricated by known microcircuit techniques. The invention has been implemented on a portable device that identifies chemicals by their unique color signatures. The device claims to allow scientists to recognize potentially deadly chemicals right on the scene of crime, terrorist attacks, or industrial accidents.

However, none of the inventions is regarding the manipulation of the micro plasma flow, which is important in many technology fields as mentioned above. Therefore, the invention here is focused on the manipulation of the micro plasma flow.

The invention can be used for many applications. In one embodiment, the invention can be used for the fields of medical, veterinary, food and environmental diagnostics. In another embodiment, the invention can be used in the field of MEMS, which requires the manipulation of the micro fluid flow, such as driving the micro fluid to flow in and flow out of the micro channels for the cooling of electronics devices. In a further embodiment, the invention may be used to drive the micro fluid flowing inside a micro-, or a nano-scale medical device for the purpose of heating, drug material delivery, samples mixing or interactions, cleaning, or dehydration.

### SUMMARY OF THE INVENTION

The embodiment of the present invention provides an apparatus and method, which uses the micro plasma to manipulate the micro fluid flow field.

In one embodiment, the electrically conductive traces on the microstrip structures may be used to apply the RF or microwave powers and therefore the micro plasma is excited.

In one embodiment, the micro cavity from waveguide structures may be used to apply the RF or microwave powers and therefore the micro plasma is excited.

In one embodiment, a pair of parallel conductive traces may be applied with microwave or RF electromagnetic energies to minimize the electromagnetic radiation.

In one embodiment, the phase, amplitude, and time delay of the RF and microwave sources may be adjustable, and the applied sources may be time dependent, therefore the micro plasma field may be perturbed and used to manipulate the micro fluid flow.

In one embodiment, the RF and microwave sources, phase shifters, power amplifiers, amplitude adjusters, sources switchers, and the electrically conductive traces may be manufactured on an integrated circuit device.

In one embodiment, the components near the micro plasma actuators may be applied with time-dependent electrical potentials, and an external magnetic field may be applied to the micro plasma actuator, therefore a perturbation of the micro plasma field may be used to manipulate the micro fluid flow.

In one embodiment, the magnetic field may be provided by a permanent magnetic, or by electromagnetic coils.

In one embodiment, the ferromagnetic material may couple to the coils to provide magnetic field.

In one embodiment, the electrically conductive traces may be manufactured on a printed circuit board and the printed circuit board may be made of rigid or flexible material.

In one embodiment, the waveguide structure may be made on the printed circuit board structure.

In one embodiment, the electrically conductive traces may be microstrip, embedded microstrip, or striplines structure.

In one embodiment, the conductive traces may be made with different scale, such as, a bulk scale, a micron-meter scale, or a nano-meter scale.

In one embodiment, the micro fluid flow may be guided with guided structure, the guided structure may be electrically conductive or nonconductive, and the guided structure may have many segments, and each segment may be applied with different electrical potentials to perturb the micro fluid flow.

In one embodiment, a valve and a solid component may be coupled with the micro plasma actuators to change the gas flow direction.

In one embodiment, the guided structure may have different configurations and the micro plasma may be in an array.

In one embodiment, the device may be used to drive different gases to mix together.

In one embodiment, the micro plasma actuators may be embedded inside the heat sink base, and to induce gas flow to cool down the heat sink fins.

### BRIEF DESCRIPTION OF THE DRAWINGS

A better understanding of the present invention may be obtained when the following detailed description is considered in conjunction with the following drawings, in which:

FIG. 1a illustrates a micro device, which has the micro fluid to flow in and flow out;

FIG. 1b illustrates a LIGA micro mixer device;

FIG. 2a illustrates that the micro plasma is generated with a pair of parallel electrically conductive traces on top of a dielectric layer;

FIG. 2b illustrates that the micro plasma is coupled with guided structure;

FIG. 2c illustrates that the micro plasma is coupled with guided structure and a component, the guided structure and component may be applied with electrical potentials;

FIG. 3a illustrates that the micro plasma is generated in between two parallel electrically conductive traces;

FIG. 3b illustrates that the micro plasma is generated in between two parallel electrically conductive traces and the micro plasma flow field may be manipulated by the electrical potentials applied on the nearby components;

FIG. 3c illustrates that the micro plasma may be manipulated by a magnetic field;

FIG. 4 illustrates the means to excite the micro plasma;

FIG. 5a-5d illustrate the manipulation of the micro fluid flow with micro plasma;

FIG. 6a-6b illustrate the manipulation of the micro fluid flow with micro plasma and magnetic field;

FIG. 7 illustrates that the waveguide structure is used to generate micro plasma and the micro plasma flow field may be manipulated by the magnetic field;

FIG. 8a illustrates that the micro plasma may be generated on the electrically conductive traces on the substrate and the micro plasma flow field may be manipulated by a magnetic field;

FIG. 8b to 8d illustrate that the magnetic field may be generated with the coils and the coil may be planar or non-planar, and a ferromagnetic material may be coupled with the coils;

FIG. 9a illustrates the micro plasma flow may be manipulated by a valve, a solid block, or a component;

FIG. 9b illustrates that guided structure may have various configurations and the micro plasma actuators may be in an array configuration.

FIG. 9c illustrates that the micro plasma actuator couple to a heat sink assembly to induce a gas flow to cool down the heat source.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

The invention generally relates to a method and apparatus for providing RF or microwave power sources to the electrically conductive traces or waveguide structures, and therefore the micro plasma is generated. The generated micro plasma is manipulated with various mechanisms to drive the micro fluid flow.

Several terminologies used in the patent are explained here. As used herein “dielectric” is a substance that is a poor conductor of electricity, but an efficient supporter of electrostatic fields. In practice, most dielectric materials are solid. An important property of a dielectric is its ability to support an electrostatic field while dissipating minimal energy in the form of heat. The lower the dielectric loss (the proportion of energy lost as heat), the more effective is a dielectric material. Another consideration is the dielectric constant, the extent to which a substance concentrates the electrostatic lines of flux. Substances with a low dielectric constant include a perfect vacuum, dry air, and most pure, dry gases such as helium and nitrogen. Materials with moderate dielectric constants include ceramics, distilled water, paper, mica, polyethylene, and glass. Metal oxides, in general, have high dielectric constants.

As used herein “transmission line” or “conductor traces” are the material medium or structure that forms all or part of a path from one place to another for directing the transmission of energy, such as electromagnetic waves or acoustic waves, as well as electric power transmission. Components of transmission lines include conductor lines on printed circuit boards, wires, coaxial cables, dielectric, slabs, optical fibers, electric power lines, and waveguides.

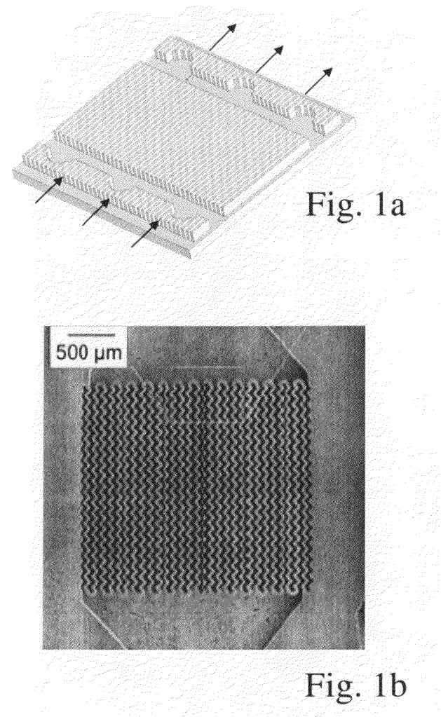

FIG. 1 illustrates an example of micro device, which requires the micro fluid to flow in and flow out the device. However, because of the small dimension, such as, small pitch or small gap distance, it may become very difficult to drive the fluid to flow in and out. The reasons may be due to the viscous effect from sold surfaces, big pressure drop between inlet and outlet of the device, and the difficulty of making drivers and actuators in a small scale to fit with the micro structures. From the energy pint of view, if bulk actuators are needed to drive the fluid flow, it is likely that the actuators will consume high energy in order to conquer the pressure drop and the viscosity. From a cost point of view, if many of small actuators are used but not well designed, then the manufacturing complication and the materials may increase the budget a lot. Therefore, in this patent, a simple but robust driving mechanism to manipulate the fluid flow is proposed. The invention uses micro plasma to drive the micro fluid flow inside the microstructures. The micro plasma may be excited with RF or microwave electromagnetic waves. By careful design, the RF or microwave energy may be concentrated at specific local regions to excite the micro plasmas and to drive the micro fluid flow.

FIG. 1b illustrates a micro device was made using LIGA technique, by W. Erhfeld, and it is used for micro fluid mixer. The details of the work was published on the Journal of Ind. Eng. Chem. Res., in 1999, volume 38, page 1077. As it can be seen that more and more applications of micro reactors are in use or under development, which indicates the need of better micro actuators for future devices in various fields. The patent here propose a unique and robust of driving micro gas flow which will be useful in the applications.

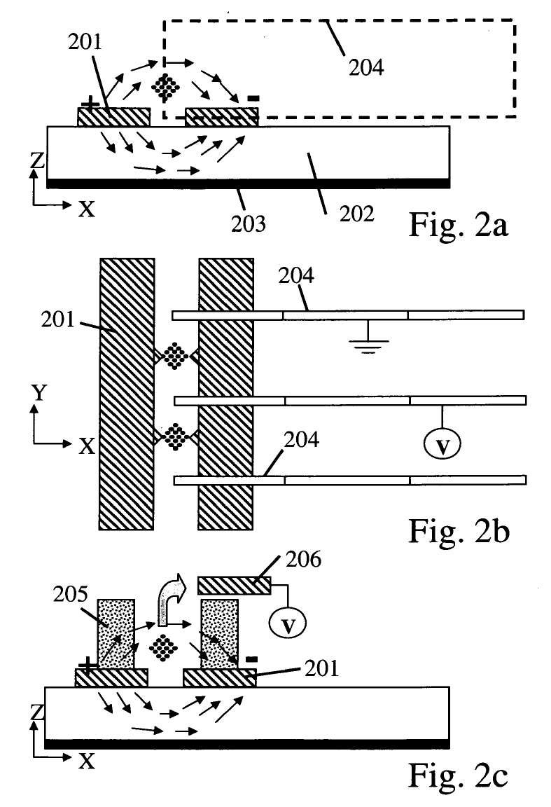

FIG. 2a illustrates an example of generating micro plasma. The configuration shows that a pair of parallel electrically conductor traces 201 are on top of a dielectric layer 202, and at the bottom is a ground layer 203. A pair of differential signals may be applied to the traces. When the two signals are applied in a way that making common signal very small, the system may have lower electromagnetic interference and may be helpful in passing the EMI/EMC standard. The differential signaling has been used more and more for high-speed data transmission. The two RF or microwave sources applied to the two electrically conductive traces may make the regions, such as the dots shown in FIG. 2, to have high electrical fields, and hence, the gas fluid in the regions will be strongly or weakly ionized. The micro plasma is therefore generated in the regions. The controlled movement of generated micro plasma is the key to the manipulation of the micro fluid flow. The collisions of ions, electrons, and neutral fluid particles may cause the movement of the gas flow. The movements of the micro plasma may be affected by a few factors, such as, the electrical potentials of nearby components, and the magnetic fields. FIG. 2b illustrates that the guided structure 204 may be applied with various electrical potentials. In one embodiment, the guided structure 204 may have many segments, and the segments may be electrically conductive or non-conductive, and the segments may be applied with different electrical potentials. In another embodiment, the applied electrical potentials may be transient. The guided structure 204 is used to guide the movement of the gas flow. FIG. 2c illustrates the dielectric materials 205, and an electrically conductive component 206 with an applied electrical potential, may coupled to the conductive traces 201 to manipulate the micro plasma flow.

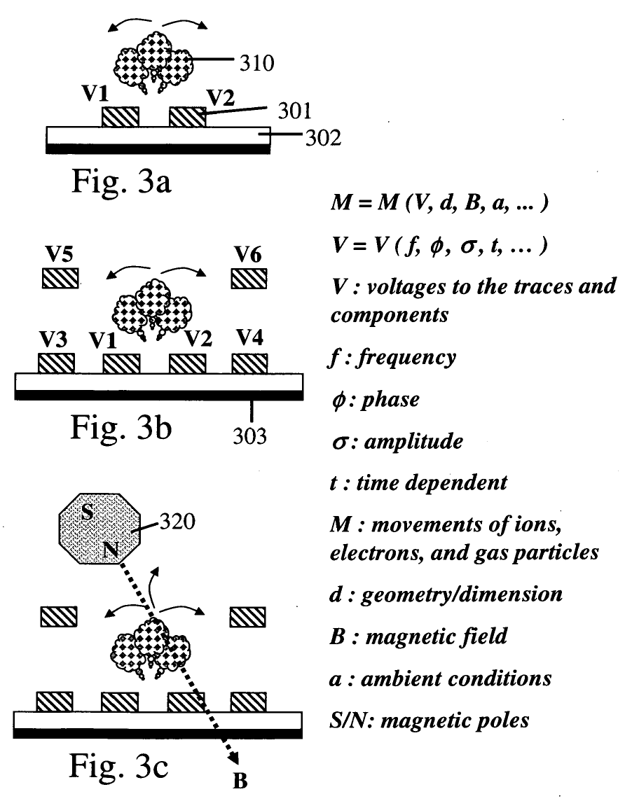

FIG. 3a illustrates the movement of the micro plasma flow. The movement of the micro plasma 310, which is symbolized as M, is dependent of several factors, such as, voltages applied to conductive traces, which is symbolized as V, geometry and dimensions of the components of the actuators, which is symbolized as d, magnetic field, which is symbolized as B, and ambient factors, which is symbolized as a. The ambient factors, for example, can be humidity, pressure, and temperature of the gas fluid. The RF and microwave signals applied to the electrically conductive traces 301 may be varied in frequency f, phase φ, amplitude σ, and the signals may be time dependent and may have various waveforms. When any one of these factors is altered, the micro plasma may experience a perturbation or turbulence. In one embodiment, the manipulation of the perturbation and turbulence of the micro plasma may be used to move the gas flow. FIG. 3b illustrates that the movement of micro plasma may be manipulated by the electrical potentials of nearby components, such as V5 and V6. FIG. 3c illustrates that a magnetic field 320 may also affect the movement of the micro plasma. In one embodiment, the magnetic field may be generated by a permanent magnet or by a coil applied with electrical current.

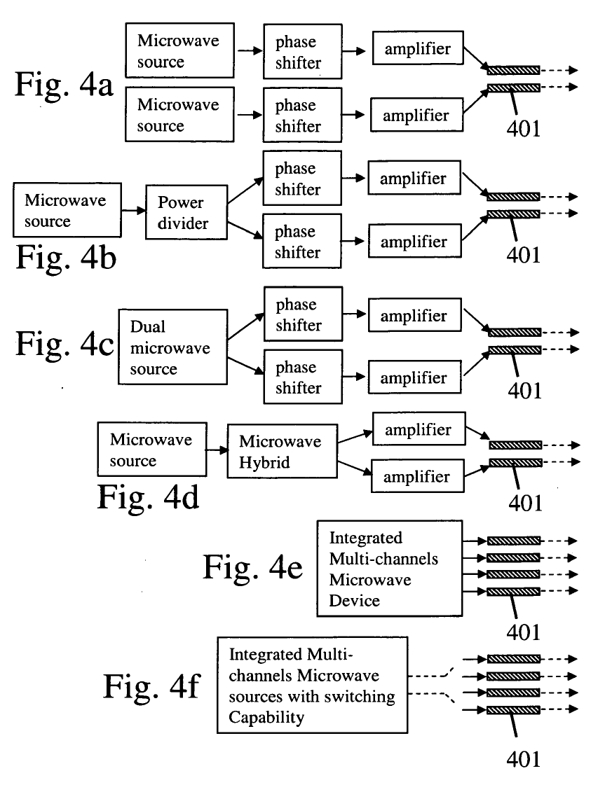

To perturb the micro plasma field, a circuit or setup is needed. FIG. 4 illustrates several possible configurations to apply the RF or microwave powers to the pair of electrically conductive traces. In one embodiment, the amplitude, the phase, the frequency, and the waveform of the power source may be adjusted and controlled to perturb the micro plasma flow. In one embodiment, each block in FIG. 4 represents a controller, which may be used to perturb the RF or microwave fields. In a further embodiment, all these factors may be implemented within integrated circuit devices, and the integrated circuit devices may be multi-channels and may have switching capability. Therefore, an array of the traces may be utilized to control complicated micro plasma flow.

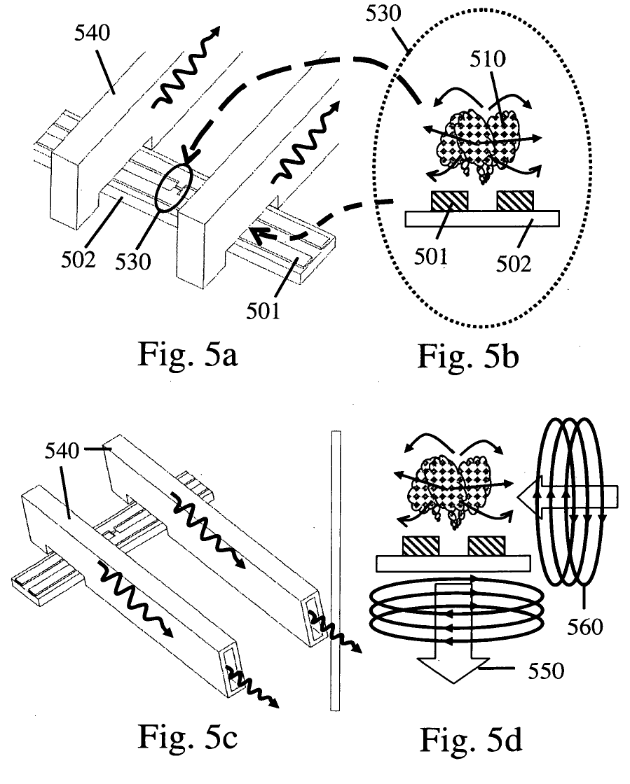

FIG. 5a to 5d illustrate examples of using excited micro plasma 510 to drive the gas flow. In FIG. 5a, the micro plasma actuators 530 are coupled to the guided structures 540. A micro plasma actuator 530, which is not covered by guided structure 540 is shown in the middle. The electrically conductive traces may have patterns, such as the one shown in the figure, to make the distance between traces smaller, therefore the electrical field will be higher at that local region, for the ease of exciting micro plasma. The guided structure 540 is used to guide the gas flow. In one embodiment, when micro plasma 510 is perturbed at one location, the gas flow may be perturbed to move along the guided structure 540, as the direction of arrow shown in FIG. 5a. FIG. 5c and 5d illustrate a magnetic field 550 may be coupled with the micro plasma actuator 530. FIG. 5d illustrates the magnetic field 550 is provided by the coils 560. In one embodiment, the direction of the magnetic field 550 may be altered when the direction of the current applied to the coil is changed. In one embodiment, the strength of the magnetic field 550 may be adjusted with the amplitude of the applied current to the coils 560. In a further embodiment, the applied electrical current may be transient. A short transient impulse current applied to the coils may induce high magnetic field and therefore the micro plasma flow field may be manipulated accordingly. In FIG. 5d, the magnetic fields are in horizontal and vertical directions. In one embodiment, the coils 560 may be tilted an arbitrary angle with respect to the micro plasma actuators 530. Furthermore, the magnetic field 550 may be provided by a permanent magnet.

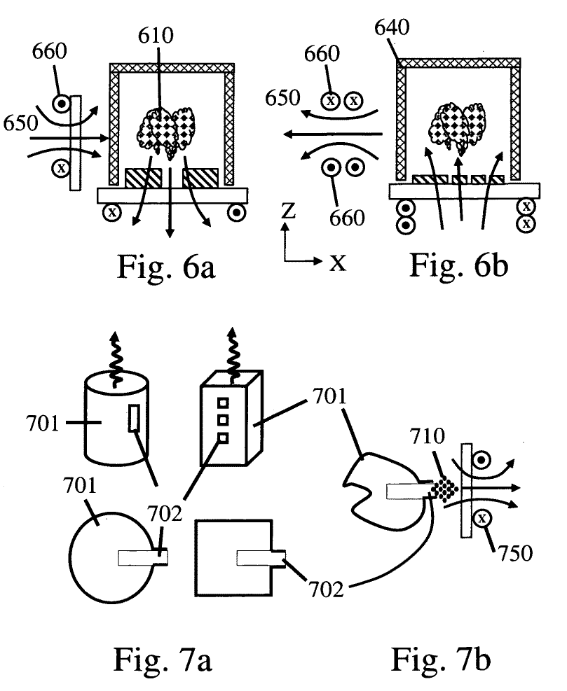

FIG. 6a and 6b illustrate the magnetic field 650 is provided by the electrical currents applied to the coils 660, and the magnetic field 650 is to perturb the micro plasma 610 flow. The figures show that a guided structure 640 is used. FIG. 6b illustrates, besides the differential pairs, any other configurations of the electrically conductive traces may be used to excite micro plasma 610. In one embodiment, the coils may have various configurations, such as, planar circular spiral coil, 3D spiral coil, rectangular spiral coil, toroidal coil, trarpoidal coil, or other irregular shape coil.

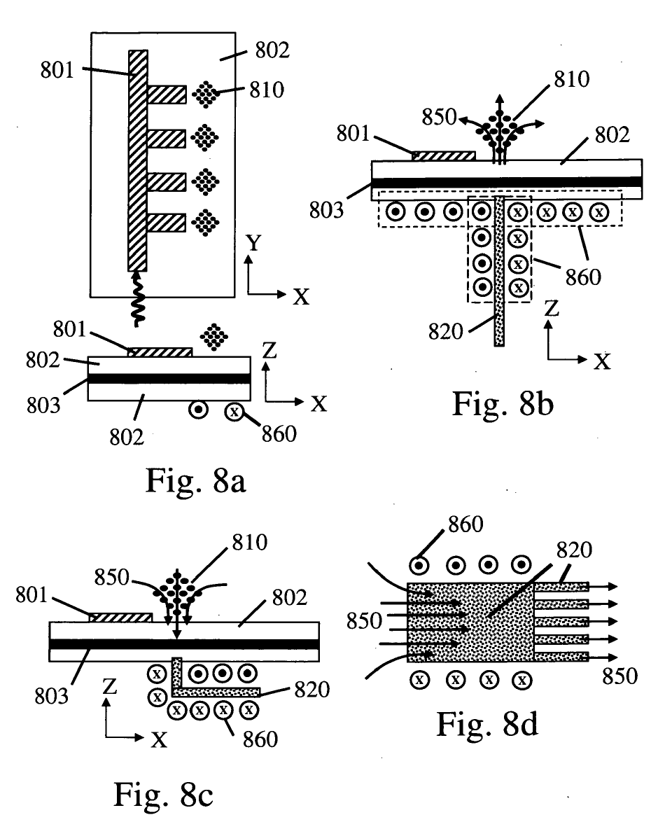

FIG. 7 illustrates that micro plasma may be excited with waveguide structure 701. The RF or microwave power pass through the waveguide structure 701 may have energy leaking out at the holes or slots 702 as shown in FIG. 7a and 7b. By careful design of the waveguide structure, the locations and geometries of the holes or slots 702, the high RF or microwave energy may occur at these exit locations. Hence the micro plasma 710 may be excited at these locations. Similar as FIG. 6a and 6b, a magnetic field may be applied to perturb the micro plasma flow field.

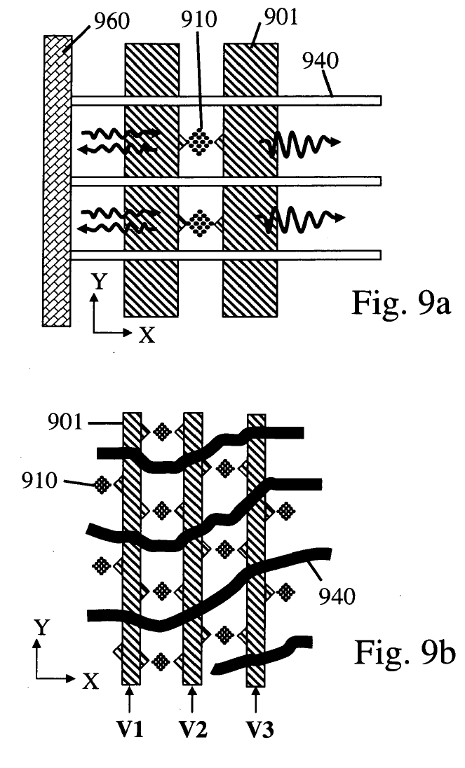

As explained in FIG. 6b, the electrically conductive traces 801 may have different configurations and FIG. 8a illustrates one example of microstrip structure, which has stud patterns. In one embodiment, different configurations of microstrips may be used to excite the micro plasma 810, and all the variations of the structures should be considered within the scope of the embodiment here. In another embodiment, a ferromagnetic material 820 may couple to traces 801, dielectric layer 802, ground 803, and coils 860. The ferromagnetic material 820, which has higher magnetic permeability, is usually used to concentrate the magnetic induction and therefore is useful to provide higher magnetic fields 850 at specific locations. The coils 860 can be planar or non-planar as shown in FIG. 8b. Similarly, the ferromagnetic material 820 may have different configurations to couple with coils 860, as shown in FIG. 8b and 8c. FIG. 8d illustrates the ferromagnetic material 820 may have some small portions and the magnetic field 850 may be designed to be high at the tip of these small portions for the coupling with micro plasma 810, RF and microwave electromagnetic energies, and gas flow. In one embodiment, electrically conductive traces 810, ferromagnetic materials 820, dielectric layers 802, and coils may be manufactured altogether on the same substrate, for example, using the PCB manufacturing techniques, which may have multi-layers structure.

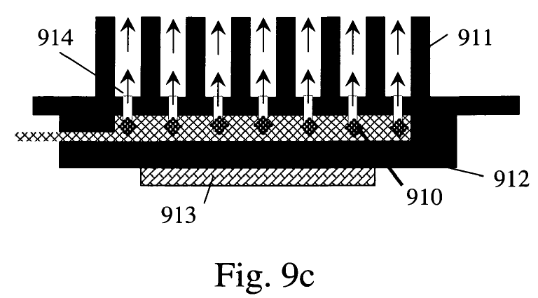

As mentioned earlier, the guided structure 940 is used to guide the micro gas flow. FIG. 9a illustrates a top view of one configuration. The micro plasma 910 is generated between two electrically conductive traces 901. In one embodiment, a valve 960 may be used to control the micro gas flow. The valve may be designed to have high flow resistance in one direction, but low flow resistance in another direction. In this way, the flow direction may be controlled.

FIG. 9b illustrates that the guided structure 940 may have various configurations to direct the micro gas flow. The micro plasma 910 and electrically conductive traces 901 may be arranged in arrays to drive the micro gas flow in various directions. In one embodiment, the electrically conductive traces may be applied with various voltages, currents, and powers to manipulate the micro gas flow.

FIG. 9c illustrates that the micro plasma actuators 910 are embedded inside the heat sink base 912. The micro plasma may be excited on the conductive traces, and the conductive traces may be built on a substrate, such as PCB or flexible PCB, and the entire PCB may be inserted inside a cavity inside the heat sink base. The excited micro plasma may induce a gas flow to flow out the holes 914, as shown in FIG. 9c. The heat from the heat source 912 is conducted to heat sink base 912 and heat sink fins 911 through conduction mechanism. The micro plasma induced gas flow will carry the heat on the heat sink fins 911 to outside ambient. Therefore, the heat source 913 is cooled. The current mechanism is basically to induce a forced convection to cool down the heat sink fins and heat source.

In one embodiment, the micro fluid material can be gas or liquid. When the fluid material is in gas state, the gas particles may be ionized with RF or microwave energies. When the fluid material is liquid state, the liquid particles may be ionized as well.

What is claimed is: //

1. A method and apparatus for applying RF or microwave energy on electrically conductive traces, and waveguide structures to generate micro plasma, and the micro plasma is manipulated with mechanisms to drive the micro fluid flow;

2. The apparatus of claim 1, further comprising electrical conductive traces, wherein the conductive traces are applied with voltages to ionize the air in between the traces and therefore to generate micro plasma;

3. The apparatus of claim 1, wherein the electrical conductive trace may be single trace line or pair lines, wherein the pair lines are two parallel traces coupled together;

4. The apparatus of claim 1, wherein the waveguide structures is composed of electrically conductive material to fully enclose or partially contain the electromagnetic waves, and the waveguide structure may contain holes, slots, to excite the micro plasma at the locations, in order to induce gas flow;

5. The apparatus of claim 1, the polarity, amplitude, frequency, phase, and time step of the applied RF or microwave energy is adjustable; the voltages applied to the pair of conductive traces are controlled to have either common mode or differential mode;

6. The apparatus of claim 1, wherein the mechanism includes the variable voltages applied to the signal traces, controlling the electrical potentials of the nearby components near the signal traces, applying an variable external magnetic field to the plasma region, and using the guided structure to move the micro plasma gas flow along a specific direction;

7. The apparatus of claim 1, wherein the conductive traces may have patterns, and the conductive traces may be parallel to each other to form a differential pair; and the conductive traces may have nearby traces, wherein the nearby traces are applied with variable potential to perturb the micro plasma gas flow excited by the parallel traces; and the nearby traces can be acted as guided traces to prevent the electromagnetic leakage to external environment;

8. The apparatus of claim 1, wherein the RF and microwave power are composed with sources element, phase shifter element, power amplifier element, power divider element, hybrid element, power switching element, and integrated circuit elements;

9. The apparatus of claim 1, wherein the generated micro plasma is confined inside a guided structure, the micro plasma induced gas flow is flowing along the guided structure; and the micro plasma gas flow may be perturbed by an external magnetic field so the gas flow become dynamic and turbulent;

10. The apparatus of claim 1, wherein the generated micro plasma is perturbed by an external magnetic field and the magnetic field is provided by an Page 16 electromagnetic, a permanent magnet, or a coil, the coil is applied with an electrical current; the magnetic field direction can be in plane, out of plane, or with an angle with respect to the plane the apparatus is sitting;

11. The apparatus of claim 1, wherein the micro plasma may be excited inside a cavity structure and a waveguide structure, the excited micro plasma gas flow may be either pushed in, or pushed out a hole, by an external magnetic field;

12. The apparatus of claim 1, wherein the micro plasma may be excited by a microstrip trace, the trace may have stud structures to form a multi-channel actuators; the micro plasma gas flow may be perturbed by an magnetic field, the magnetic field may be provided by the coils applied with current, and a ferromagnetic material may be coupled to the coils to enhance the magnetic field strength at local regions; and the ferromagnetic material may be in a thin film structure, or a column structure;

13. The apparatus of claim 1, wherein the micro plasma actuators may be arranged to have array configuration, and guided structures may be arranged to have array configuration to accommodate the micro plasma actuators;

14. The apparatus of claim 1, wherein the micro plasma is embedded inside a heat sink base, the heat sink base may have passage and holes to allow the micro plasma induced gas to flow out, the micro plasma induce gas flow is to flow along the heat sink fins and to cool down the heat sink fins and heat source.

15. The apparatus of claim 1, wherein the micro fluid flow is used to embedded inside a heat sink base, the heat sink base may have passage and holes to allow the micro plasma induced gas to flow out, the micro plasma induce gas flow is to flow along the heat sink fins and to cool down the heat sink fins and source.

16. The apparatus of claim 1, wherein the conductive traces and waveguide structure may be manufactured to be a cavity structure, the cavity structure may be excited with RF and microwave energy at the cavity's resonant frequency, the micro plasma excited by the cavity structure is used to induce the gas movement and flowing motion.
